(19) United States
(12) Patent Application Publication
(10) Pub. No.: US 2021/0374986 A1
(43) Pub. Date: Dec. 2, 2021

(54) IMAGE PROCESSING TO DETERMINE OBJECT THICKNESS

(71) Applicant: IMPERIAL COLLEGE OF SCIENCE, TECHNOLOGY AND MEDICINE, London (GB)

(72) Inventors: Andrea NICASTRO, London (GB); Ronald CLARK, London (GB); Stefan LEUTENEGGER, Munich (DE)

(21) Appl. No.: 17/405,955

(22) Filed: Aug. 18, 2021

Related U.S. Application Data
(63) Continuation of application No. PCT/GB2020/050380, filed on Feb. 18, 2020.

(30) Foreign Application Priority Data
Feb. 20, 2019 (GB) 1902338.1

(51) Int. Cl. G06T 7/60; G06T 7/11; G06T 15/06; G06K 9/00

(52) U.S. Cl. CPC G06T 7/60; G06T 7/11; G06T 15/06; G06K 9/00664; G06T 2207/10028; G06T 2207/20081; G06T 2207/10016; G06T 2207/10024; G06T 2207/20084

(57) ABSTRACT

Examples are described that process image data to predict a thickness of objects present within the image data. In one example, image data for a scene is obtained, the scene featuring a set of objects. The image data is decomposed to generate input data for a predictive model. This may include determining portions of the image data that correspond to the set of objects in the scene, where each portion corresponding to a different object. Cross-sectional thickness measurements are predicted for the portions using the predictive model. The predicted cross-sectional thickness measurements for the portions of the image data are then composed to generate output image data comprising thickness data for the set of objects in the scene.

### CROSS-REFERENCE TO RELATED APPLICATIONS

This application is a continuation of International Application No. PCT/GB2020/050380, filed Feb. 18, 2020 which claims priority to United Kingdom Application No. GB 1902338.1, filed Feb. 20, 2019, under 35 U.S.C. § 119(a). Each of the above-referenced patent applications is incorporated by reference in its entirety.

### BACKGROUND

### Field of the Invention

The present invention relates to image processing. In particular, the present invention relates to processing image data to estimate thickness data for a set of observed objects. The present invention may be of use in the fields of robotics and autonomous systems.

### Description of the Related Technology

Despite advances in robotics over the last few years, robotic devices still struggle with tasks that come naturally to human beings and primates. For example, while multi-layer neural network architectures demonstrate near-human levels of accuracy for image classification tasks, many robotic devices are unable to repeatedly reach out and grasp simple objects in a normal environment.

One approach to enable robotic devices to operate in a real-world environment has been to meticulously scan and map the environment from all angles. In this case, a complex three-dimensional model of the environment may be generated, for example in the form of a “dense” cloud of points in three-dimensions representing the contents of the environment. However, these approaches are onerous, and it may not always be possible to navigate around the environment to provide a number of views to construct an accurate model of the space. These approaches also often demonstrate issues with consistency, e.g. different parts of a common object observed in different video frames may not always be deemed to be part of the same object.

Newcombe et al, in their paper “Kinectfusion: Real-time dense surface mapping and tracking”, published as part of the 2011 10th IEEE International Symposium on Mixed and Augmented Reality (see pages 127-136), describes an approach for constructing scenes from RGBD (Red, Green, Blue and Depth channel) data, where multiple frames of RGBD data are registered and fused into a three-dimensional voxel grid. Frames of data are tracked using a dense six-degree-of-freedom alignment and then fused into the volume of the voxel grid.

McCormac et al, in their 2018 paper “Fusion++: Volumetric object-level slam”, published as part of the International Conference on 3D Vision (see pages 32-41), describe an object-centric approach to large scale mapping of environments. A map of an environment is generated that contains multiple truncated signed distance function (TSDF) volumes, each volume representing a single object instance.

It is desired to develop methods and systems that make it easier to develop robotic devices and autonomous systems that can successfully interact with, and/or navigate, an environment. It is further desired that these methods and systems operate at real-time or near-real time speeds, e.g. such that they may be applied to a device that is actively operating within an environment. This is difficult as many state-of-the-art approaches have extensive processing demands. For example, recovering three-dimensional shapes from input image data may require three-dimensional convolutions, which may not be possible within the memory limits of most robotic devices.

### SUMMARY

According to a first aspect of the present invention there is provided a method of processing image data, the method comprising: obtaining image data for a scene, the scene featuring a set of objects; decomposing the image data to generate input data for a predictive model, including determining portions of the image data that correspond to the set of objects in the scene, each portion corresponding to a different object; predicting cross-sectional thickness measurements for the portions using the predictive model; and composing the predicted cross-sectional thickness measurements for the portions of the image data to generate output image data comprising thickness data for the set of objects in the scene.

In certain examples, the image data comprises at least photometric data for a scene and decomposing the image data comprises generating segmentation data for the scene from the photometric data, the segmentation data indicating estimated correspondences between portions of the photometric data and the set of objects in the scene. Generating segmentation data for the scene may comprise detecting objects that are shown in the photometric data and generating a segmentation mask for each detected object, wherein decomposing the image data comprises, for each detected object, cropping an area of the image data that contains the segmentation mask, e.g. cropping the original image data and/or the segmentation mask. Detecting objects that are shown in the photometric data may comprise detecting the one or more objects in the photometric data using a convolutional neural network architecture.

In certain examples, the predictive model is trained on pairs of image data and ground-truth thickness measurements for a plurality of objects. The image data may comprise photometric data and depth data for a scene, wherein the input data comprises data derived from the photometric data and data derived from the depth data, the data derived from the photometric data comprising one or more of colour data and a segmentation mask.

In certain examples, the photometric data, the depth data and the thickness data may be used to update a three-dimensional model of the scene, which may be a truncated signed distance function (TSDF) model.

In certain examples, the predictive model comprises a neural network architecture. This may be based on a convolutional neural network, e.g. approximating a function on input data to generate output data, and/or may comprise an encoder-decoder architecture. The image data may comprise a colour image and a depth map, wherein the output image data comprises a pixel map comprising pixels that have associated values for cross-sectional thickness.

According to a second aspect of the present invention there is provided a system for processing image data, the system comprising: an input interface to receive image data; an output interface to output thickness data for one or more objects present in the image data received at the input interface; a predictive model to predict cross-sectional thickness measurements from input data, the predictive model being parameterised by trained parameters that are estimated based on pairs of image data and ground-truth thickness measurements for a plurality of objects; a decomposition engine to generate the input data for the predictive model from the image data received at the input interface, the decomposition engine being configured to determine correspondences between portions of the image data and one or more objects deemed to be present in the image data, each portion corresponding to a different object; and a composition engine to compose a plurality of predicted cross-sectional thickness measurements from the predictive model to provide the output thickness data for the output interface.

In certain examples, the image data comprises photometric data and the decomposition engine comprises an image segmentation engine to generate segmentation data based on the photometric data, the segmentation data indicating estimated correspondences between portions of the photometric data and the one or more objects deemed to be present in the image data. The image segmentation engine may comprise a neural network architecture to detect objects within the photometric data and to output segmentation masks for any detected objects, such as a region-based convolutional neural network—RCNN—with a path for predicting segmentation masks.

In certain examples, the decomposition engine is configured to crop sections of the image data based on bounding boxes received from the image segmentation engine, wherein each object detected by the image segmentation engine has a different associated bounding box.

In certain examples, the image data comprises photometric data and depth data for a scene, and wherein the input data comprises data derived from the photometric data and data derived from the depth data, the data derived from the photometric data comprising a segmentation mask.

In certain examples, the predictive model comprises an input interface to receive the photometric data and the depth data and to generate a multi-channel feature image; an encoder to encode the multi-channel feature image as a latent representation; and a decoder to decode the latent representation to generate cross-sectional thickness measurements for a set of image elements.

In certain examples, the image data received at the input interface comprises one or more views of a scene, and the system comprises a mapping system to receive output thickness data from the output interface and to use the thickness data to determine truncated signed distance function values for a three-dimensional model of the scene.

According to a third aspect of the present invention there is provided of training a system for estimating a cross-sectional thickness of one or more objects, the method comprising obtaining training data comprising samples for a plurality of objects, each sample comprising image data and cross-sectional thickness data for one of the plurality of objects and training a predictive model of the system using the training data. This last operation may include providing image data from the training data as an input to the predictive model and optimising a loss function based on an output of the predictive model and the cross-sectional thickness data from the training data.

In certain examples, object segmentation data associated with the image data is obtained and an image segmentation engine of the system is trained, including providing at least data derived from the image data as an input to the image segmentation engine and optimising a loss function based on an output of the image segmentation engine and the object segmentation data. In certain cases, each sample comprises photometric data and depth data and training the predictive model comprises providing data derived from the photometric data and data derived from the depth data as an input to the predictive mode. Each sample may comprise at least one of a colour image and a segmentation mask, a depth image, and a thickness rendering for an object.

According to a fourth aspect of the present invention there is provided a method of generating a training set, the training set being useable to train a system for estimating a cross-sectional thickness of one or more objects, the method comprising, for each object in a plurality of objects: obtaining image data for the object, the image data comprising at least photometric data for a plurality of pixels; obtaining a three-dimensional representation for the object; generating cross-sectional thickness data for the object, including: applying ray-tracing to the three-dimensional representation to determine a first distance to a first surface of the object and a second distance to a second surface of the object, the first surface being closer to an origin for the ray-tracing than the second surface; and determining a cross-sectional thickness measurement for the object based on a difference between the first distance and the second distance, wherein the ray-tracing and the determining of the cross-sectional thickness measurement is repeated for a set of pixels corresponding to the plurality of pixels to generate the cross-sectional thickness data for the object, the cross-sectional thickness data comprising the cross-sectional thickness measurements and corresponding to the obtained image data; and generating a sample of input data and ground-truth output data for the object, the input data comprising the image data and the ground-truth output data comprising the cross-sectional thickness data.

In certain examples, the method comprises: using the image data and the three-dimensional representations for the plurality of objects to generate additional samples of synthetic training data. The image data may comprise photometric data and depth data for a plurality of pixels.

According to a fifth aspect of the present invention there is provided a robotic device comprising: at least one capture device to provide frames of video data comprising colour data and depth data; the system of any one of the above examples, wherein the input interface is communicatively coupled to the at least one capture device; one or more actuators to enable the robotic device to interact with a surrounding three-dimensional environment; and an interaction engine comprising at least one processor to control the one or more actuators, wherein the interaction engine is to use the output image data from the output interface of the system to interact with objects in the surrounding three-dimensional environment.

According to a sixth aspect of the present invention there is provided a non-transitory computer-readable storage medium comprising computer-executable instructions which, when executed by a processor, cause a computing device to perform any of the methods described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1A is a schematic diagram showing an example of a three-dimensional (3D) space;

FIG. 1B is a schematic diagram showing available degrees of freedom for an example object in three-dimensional space;

FIG. 1C is a schematic diagram showing image data generated by an example capture device;

FIG. 2 is a schematic diagram of a system for processing image data according to an example;

FIG. 3A is a schematic diagram showing a set of objects being observed by a capture device according to an example;

FIG. 3B is a schematic diagram showing components of a decomposition engine according to an example;

FIG. 4 is a schematic diagram showing a predictive model according to an example;

FIG. 5 is a plot comparing a thickness measurement obtained using an example with a thickness measurement resulting from a comparative method;

FIG. 6 is a schematic diagram showing certain elements of a training set for an example system for estimating a cross-sectional thickness of one or more objects;

FIG. 7 is a schematic diagram showing a set of truncated signed distance function values for an object according to an example;

FIG. 8 is a schematic diagram showing components of a system for generating a map of object instances according to an example;

FIG. 9 is a flow diagram showing a method of processing image data according to an example;

FIG. 10 is a flow diagram showing a method of decomposing an image according to an example;

FIG. 11 is a flow diagram showing a method of training a system for estimating a cross-sectional thickness of one or more objects according to an example;

FIG. 12 is a flow diagram showing a method of generating a training set according to an example; and

FIG. 13 is a schematic diagram showing a non-transitory computer readable medium according to an example.

### DETAILED DESCRIPTION

Certain examples described herein process image data to generate a set of cross-sectional thickness measurements for one or more objects that feature in the image data. These thickness measurements may be output as a thickness map or image. In this case, elements of the map or image, such as pixels, may have values that indicate a cross-sectional thickness measurement. Cross-sectional thickness measurements may be provided if an element of the map or image is deemed to relate to a detected object.

Certain examples described herein may be applied to photometric, e.g. colour or grayscale, data and/or depth data. These examples allow object-level predictions about thicknesses to be generated, where these predictions may then be integrated into a volumetric multi-view fusion process. Cross-sectional thickness, as described herein, may be seen to be a measurement of a depth or thickness of a solid object from a front surface of the object to a rear surface of the object. For a given element of an image, such as a pixel, a cross-sectional thickness measurement may indicate a distance (e.g. in metres or centimetres) from a front surface of the object to a rear surface of the object, as experienced by a hypothetical ray emitted or received by a capture device observing the object to generate the image.

By making thickness predictions using a trained predictive model, certain examples allow shape information to be generated that extends beyond a set of sensed image data. This shape information may be used for robotic manipulation tasks or efficient scene exploration. By predicting object thicknesses, rather than making three-dimensional or volumetric computations, comparably high spatial resolution estimates may be generated without exhausting available memory resources and/or training data requirements. Certain examples may be used to accurately predict object thickness and/or reconstruct general three-dimensional scenes containing multiple objects. Certain examples may thus be employed in the fields of robotics, augmented reality and virtual reality to provide detailed three-dimensional reconstructions.

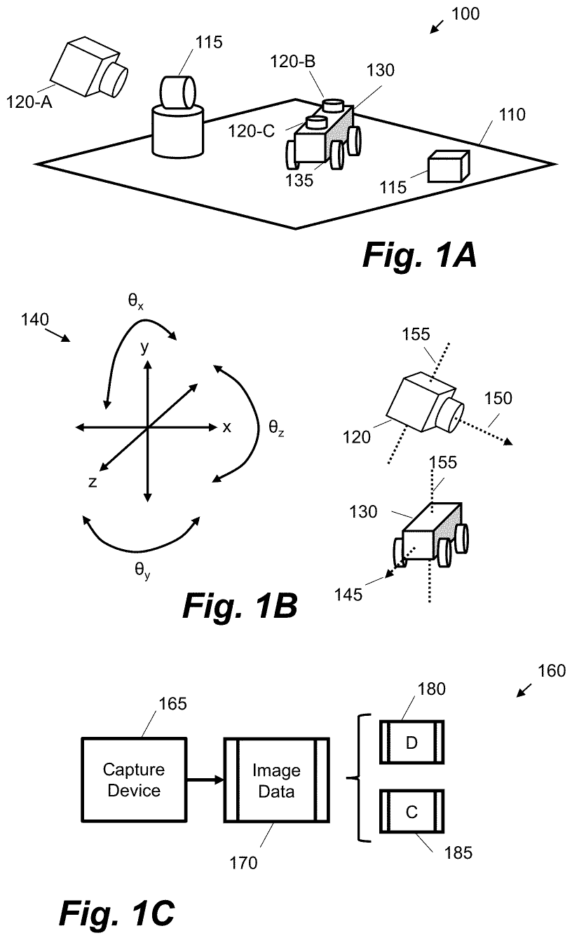

FIGS. 1A and 1B schematically show an example of a three-dimensional space and the capture of image data associated with that space. FIG. 1C then shows a capture device configured to generate image data when viewing the space, i.e. when viewing a scene. These examples are presented to better explain certain features described herein and should not be considered limiting; certain features have been omitted and simplified for ease of explanation.

FIG. 1A shows an example 100 of a three-dimensional space 110. The three-dimensional space 110 may be an internal and/or an external physical space, e.g. at least a portion of a room or a geographical location. The three-dimensional space 110 in this example 100 comprises a number of physical objects 115 that are located within the three-dimensional space. These objects 115 may comprise one or more of, amongst others: people, electronic devices, furniture, animals, building portions and equipment. Although the three-dimensional space 110 in FIG. 1A is shown with a lower surface this need not be the case in all implementations, for example an environment may be aerial or within extra-terrestrial space.

The example 100 also shows various example capture devices 120-A, 120-B, 120-C (collectively referred to with the reference numeral 120) that may be used to capture image data associated with the three-dimensional space 110. The capture device may be arranged to capture static images, e.g. may be a static camera, and/or moving images, e.g. may be a video camera where image data is captured in the form of frames of video data. A capture device, such as the capture device 120-A of FIG. 1A, may comprise a camera that is arranged to record data that results from observing the three-dimensional space 110, either in digital or analogue form. In certain cases, the capture device 120-A is moveable, e.g. may be arranged to capture different images corresponding to different observed portions of the three-dimensional space 110. In general, an arrangement of objects within the three-dimensional space 110 is referred to herein as a “scene”, and image data may comprise a “view” of that scene, e.g. a captured image or frame of video data may comprise an observation of the environment of the three-dimensional space 110 including the objects 115 within that space. The capture device 120-A may be moveable with reference to a static mounting, e.g. may comprise actuators to change the position and/or orientation of the camera with regard to the three-dimensional space 110. In another case, the capture device 120-A may be a handheld device operated and moved by a human user.

In FIG. 1A, multiple capture devices 120-B, C are also shown coupled to a robotic device 130 that is arranged to move within the three-dimensional space 110. The robotic device 135 may comprise an autonomous aerial and/or terrestrial mobile device. In the present example 100, the robotic device 130 comprises actuators 135 that enable the device to navigate the three-dimensional space 110. These actuators 135 comprise wheels in the illustration; in other cases, they may comprise tracks, burrowing mechanisms, rotors, etc. One or more capture devices 120-B, C may be statically or moveably mounted on such a device. In certain cases, a robotic device may be statically mounted within the three-dimensional space 110 but a portion of the device, such as arms or other actuators, may be arranged to move within the space and interact with objects within the space. For example, the robotic device may comprise a robotic arm. Each capture device 120-B, C may capture a different type of video data and/or may comprise a stereo image source. In one case, capture device 120-B may capture depth data, e.g. using a remote sensing technology such as infrared, ultrasound and/or radar (including Light Detection and Ranging—LIDAR technologies), while capture device 120-C captures photometric data, e.g. colour or grayscale images (or vice versa). In one case, one or more of the capture devices 120-B, C may be moveable independently of the robotic device 130. In one case, one or more of the capture devices 120-B, C may be mounted upon a rotating mechanism, e.g. that rotates in an angled arc and/or that rotates by 360 degrees, and/or is arranged with adapted optics to capture a panorama of a scene (e.g. up to a full 360-degree panorama).

FIG. 1B shows an example 140 of possible degrees of freedom available to a capture device 120 and/or a robotic device 130. In the case of a capture device such as 120-A, a direction 150 of the device may be co-linear with the axis of a lens or other imaging apparatus. As an example of rotation about one of the three axes, a normal axis 155 is shown in the Figures. Similarly, in the case of the robotic device 130, a direction of alignment 145 of the robotic device 130 may be defined. This may indicate a facing of the robotic device and/or a direction of travel. A normal axis 155 is also shown. Although only a single normal axis is shown with reference to the capture device 120 or the robotic device 130, these devices may rotate around any one or more of the axes shown schematically as 140 as described below.

More generally, an orientation and location of a capture device may be defined in three-dimensions with reference to six degrees of freedom (6DOF): a location may be defined within each of the three dimensions, e.g. by an [x, y, z] co-ordinate, and an orientation may be defined by an angle vector representing a rotation about each of the three axes, e.g. [θₓ, θ_{y}, θ_{z}]. Location and orientation may be seen as a transformation within three-dimensions, e.g. with respect to an origin defined within a three-dimensional coordinate system. For example, the [x, y, z] co-ordinate may represent a translation from the origin to a particular location within the three-dimensional coordinate system and the angle vector—[θₓ, θ_{y}, θ_{z}]—may define a rotation within the three-dimensional coordinate system. A transformation having 6DOF may be defined as a matrix, such that multiplication by the matrix applies the transformation. In certain implementations, a capture device may be defined with reference to a restricted set of these six degrees of freedom, e.g. for a capture device on a ground vehicle the y-dimension may be constant. In certain implementations, such as that of the robotic device 130, an orientation and location of a capture device coupled to another device may be defined with reference to the orientation and location of that other device, e.g. may be defined with reference to the orientation and location of the robotic device 130.

In examples described herein, the orientation and location of a capture device, e.g. as set out in a 6DOF transformation matrix, may be defined as the pose of the capture device. Likewise, the orientation and location of an object representation, e.g. as set out in a 6DOF transformation matrix, may be defined as the pose of the object representation. The pose of a capture device may vary over time, e.g. as video data is recorded, such that a capture device may have a different pose at a time t+1 than at a time t. In a case of a handheld mobile computing device comprising a capture device, the pose may vary as the handheld device is moved by a user within the three-dimensional space 110.

FIG. 1C shows schematically an example of a capture device configuration. In the example 160 of FIG. 1C, a capture device 165 is configured to generate image data 170. In certain case, the capture device 165 may comprise a digital camera that reads and/or processes data from a charge-coupled device or complementary metal-oxide-semiconductor (CMOS) sensor. It is also possible to generate image data 170 indirectly, e.g. through processing other image sources such as converting analogue signal sources.

In FIG. 1C, the image data 170 comprises a two-dimensional representation of measured data. For example, the image data 170 may comprise a two-dimensional array or matrix of recorded pixel values at time t. Successive image data, such as successive frames from a video camera, may be of the same size, although this need not be the case in all examples. Pixel values within image data 170 represent a measurement of a particular portion of the three-dimensional space.

In the example of FIG. 1C, the image data 170 comprises values for two different forms of image data. A first set of values relate to depth data 180 (e.g. D). The depth data may comprise an indication of a distance from the capture device, e.g. each pixel or image element value may represent a distance of a portion of the three-dimensional space from the capture device 165. A second set of values relate to photometric data 185 (e.g. colour data C). These values may comprise Red, Green, Blue pixel values for a given resolution. In other examples, other colour spaces may be used and/or photometric data 185 may comprise mono or grayscale pixel values. In one case, image data 170 may comprise a compressed video stream or file. In this case, image data may be reconstructed from the stream or file, e.g. as the output of a video decoder. Image data may be retrieved from memory locations following pre-processing of video streams or files.

The capture device 165 of FIG. 1C may comprise a so-called RGB-D camera that is arranged to capture both RGB data 185 and depth (“D”) data 180. In one case, the RGB-D camera may be arranged to capture video data over time. One or more of the depth data 180 and the RGB data 185 may be used at any one time. In certain cases, RGB-D data may be combined in a single frame with four or more channels. The depth data 180 may be generated by one or more techniques known in the art, such as a structured light approach wherein an infrared laser projector projects a pattern of infrared light over an observed portion of a three-dimensional space, which is then imaged by a monochrome CMOS image sensor. Examples of these cameras include the Kinect® camera range manufactured by Microsoft Corporation, of Redmond, Wash. in the United States of America, the Xtion® camera range manufactured by ASUSTeK Computer Inc. of Taipei, Taiwan and the Carmine® camera range manufactured by PrimeSense, a subsidiary of Apple Inc. of Cupertino, Calif. in the United States of America. In certain examples, an RGB-D camera may be incorporated into a mobile computing device such as a tablet, laptop or mobile telephone. In other examples, an RGB-D camera may be used as a peripheral for a static computing device or may be embedded in a stand-alone device with dedicated processing capabilities. In one case, the capture device 165 may be arranged to store the image data 170 in a coupled data storage device. In another case, the capture device 165 may transmit the image data 170 to a coupled computing device, e.g. as a stream of data or on a frame-by-frame basis. The coupled computing device may be directly coupled, e.g. via a universal serial bus (USB) connection, or indirectly coupled, e.g. the image data 170 may be transmitted over one or more computer networks. In yet another case, the capture device 165 may be configured to transmit the image data 170 across one or more computer networks for storage in a network attached storage device. Image data 170 may be stored and/or transmitted on a frame-by-frame basis or in a batch basis, e.g. a plurality of frames may be bundled together. The depth data 180 need not be at the same resolution or frame-rate as the photometric data 185. For example, the depth data 180 may be measured at a lower resolution than the photometric data 185. One or more pre-processing operations may also be performed on the image data 170 before it is used in the later-described examples. In one case, pre-processing may be applied such that the two image sets have a common size and resolution. In certain cases, separate capture devices may respectively generate depth and photometric data. Further configurations not described herein are also possible.

In certain cases, the capture device may be arranged to perform pre-processing to generate depth data. For example, a hardware sensing device may generate disparity data or data in the form of a plurality of stereo images, wherein one or more of software and hardware are used to process this data to compute depth information. Similarly, depth data may alternatively arise from a time of flight camera that outputs phase images that may be used to reconstruct depth information. As such any suitable technique may be used to generate depth data as described in examples herein.

FIG. 1C is provided as an example and, as will be appreciated, different configurations than those shown in the Figure may be used to generate image data 170 for use in the methods and systems described below. Image data 170 may further comprise any measured sensory input that is arranged in a two-dimensional form representative of a captured or recorded view of a three-dimensional space. For example, this may comprise just one of depth data or photometric data, electromagnetic imaging, ultrasonic imaging and radar output, amongst others. In these cases, only an imaging device associated with the particular form of data may be required, e.g. an RGB device without depth data. In the examples above, depth data D may comprise a two-dimensional matrix of depth values. This may be represented as a grayscale image, e.g. where each [x, y] pixel value in a frame having a resolution of x_{R1} by y_{R1} comprises a depth value, d, representing a distance from the capture device of a surface in the three-dimensional space. Similarly, photometric data C may comprise a colour image, where each [x, y] pixel value in a frame having a resolution of x_{R2} by y_{R2} comprises an RGB vector [R, G, B]. As an example, the resolution of both sets of data may be 640 by 480 pixels.

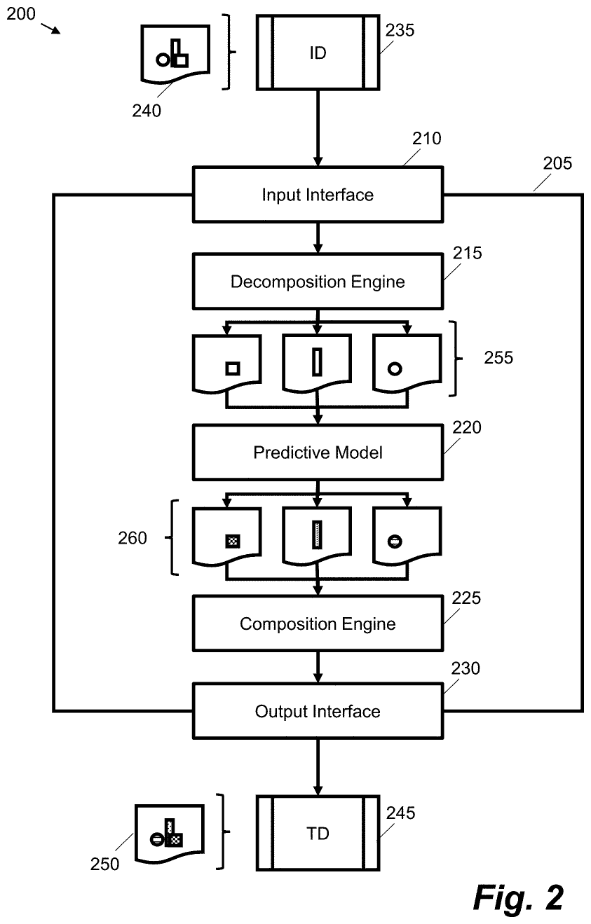

FIG. 2 shows an example 200 of a system 205 for processing image data according to an example. The system 205 of FIG. 2 comprises an input interface 210, a decomposition engine 215, a predictive model 220, a composition engine 225 and an output interface 230. The system 205, and/or one or more of the illustrated system components, may comprise at least one processor to process data as described herein. The system 205 may comprise an image processing device that is implemented by way of dedicated integrated circuits having processors, e.g. application-specific integrated circuits (ASICs) or field-programmable gate arrays (FPGAs). Additionally, and/or alternatively, the system 205 may comprise a computing device that is adapted for image processing that comprises one or more general-purpose processors, such as one or more central processing units and/or graphical processing units. The processors of the system 205 and/or its components may have one or more processing cores, with processing distributed over the cores. Each system component 210 to 230 may be implemented as separate electronic components, e.g. with external interfaces to send and receive data, and/or may form part of a common computing system (e.g. processors of one or more components may form part of a common set of one or more processors in a computing device). The system 205, and/or one or more of the illustrated system components, may comprise associated memory and/or persistent storage to store computer program code for execution by the processors to provide the functionality described herein.

In use, the system 205 of FIG. 2 receives image data 235 at the input interface. The input interface 210 may comprise a physical interface, such as a networking or Input/Output interface of a computing device and/or a software-defined interface, e.g. a virtual interface that is implemented by one or more processors. In the latter case, the input interface 210 may comprise an application programming interface (API), a class interface and/or a method interface. In one case, the input interface 210 may receive image data 235 that is retrieved from a memory or a storage device of the system 205. In another case, the image data 235 may be received over a network or other communication channel, such as a serial bus connection. The input interface 210 may be a wired and/or wireless interface. The image data 235 may comprise image data 170 as illustrated in FIG. 1C. The image data 235 represents a view of a scene 240, e.g. image data captured by a capture device within an environment when orientated to point at a particular portion of the environment. The capture device may form part of the system 205, such as in an autonomous robotic device, and/or may comprise a separate device that is communicatively coupled to the system 205. In one case, the image data 235 may comprise image data that was captured at a previous point in time and stored in a storage medium for later retrieval. The image data 235 may comprise image data as received from a capture device and/or image data 235 that results from pre-processing of image data that is received from the capture device. In certain cases, pre-processing operations may be distributed over one or more of the input interface 210 and the decomposition engine 210, e.g. the input interface 210 may be configured to normalise, crop and/or scale the image data for particular implementation configurations.

The system 205 is arranged to process the image data 235 and output, via the output interface 230, output thickness data 245 for one or more objects present in the image data 235 received at the input interface 235. The thickness data 245 may be output to correspond to the input image data 235. For example, if the input image data 235 comprises one or more of photometric and depth data at a given resolution (e.g. one or more images having a height and width in pixels), the thickness data 245 may be in the form of a “grayscale” image of the same height and width wherein pixel values for the image represent a predicted cross-sectional thickness measurement. In other cases, the thickness data 245 may be output as an “image” that is a scaled version of the input image data 235, e.g. that is of a reduced resolution and/or a particular portion of the original image data 235. In certain cases, areas of image data 235 that are not determined to be associated with one or more objects by the system 205, may have a particular value in the output thickness data 245, e.g. “0” or a special control value. The thickness data 245, when viewed as an image such as 250 in FIG. 2, may resemble an X-ray image. As such, the system 205 may be considered a form of synthetic X-ray device.

Following receipt of the image data 235 at the input interface 210, an output of the input interface 210 is received by the decomposition engine 215. The decomposition engine 215 is configured generate input data 255 for the predictive model 220. The decomposition engine 215 is configured to decompose image data received from the input interface 210 to generate the input data 255. Decomposing image data into object-centric portions improves the tractability of the predictive model 220, and allows thickness predictions to be generated in parallel, facilitating real or near real-time operation.

The decomposition engine 215 decomposes the image data received from the input interface 210 by determining correspondences between portions of the image data and one or more objects deemed to be present in the image data. In one case, the decomposition engine 215 may determine the correspondences by detecting one or more objects in the image data, e.g. by applying an image segmentation engine to generate segmentation data. In other cases, the decomposition engine 215 may receive segmentation data as part of the received image data, which in turn may form part of the image data 235. The correspondences may comprise one or more of an image mask representing pixels of the image data that are deemed to correspond to a particular detected object (e.g. a segmentation mask) and a bounding box indicating a polygon that is deemed to contain a detected object. The correspondences may be used to crop the image data to extract portions of the image data that relate to each detected object. For example, the input data 255 may comprise, as illustrated in FIG. 2, sub-areas of the original input image data for each detected object. In certain cases, the decomposition engine 215 may further remove a background of portions of the image data, e.g. using segmentation data, to facilitate prediction. If the image data 235 comprises photometric and depth data then the input data may comprise photometric and depth data that are associated with each detected object, e.g. cropped portions of image data having a width and/or height that is less that the width and/or height of the input image data 235. In certain cases, the photometric data may comprise one or more of: colour data (e.g. RGB data) and a segmentation mask (e.g. a “silhouette”) that is output following segmentation. In certain cases, the input data 255 may comprise arrays that represent smaller images of both photometric and depth data for each detected object. Depending on the configuration of the predictive model 220, the input data 255 may comprise a single multi-dimensional array for each object or multiple separate two-dimensional arrays for each object (e.g. in both cases multiple two-dimensional arrays may respectively represent different input channels from one or more of a segmentation mask output and RGBD—Red, Green, Blue and Depth data).

In FIG. 2, the predictive model 220 receives the input data 255 that is prepared by the decomposition engine 215. The predictive model 220 is configured to predict cross-sectional thickness measurements 260 from the input data 255. For example, the predictive model 220 may be configured to receive sets of photometric and depth data relating to each object as a numeric input, and to predict a numeric output for one or more image elements representing cross-sectional thickness measurements. In one case, the predictive model 220 may output an array of numeric values representing the thickness measurements. This array may comprise, or be formatted into, an image portion where the elements of the array correspond to pixel values for the image portion, the pixel values representing a predicted thickness measurement. In one case, the cross-sectional thickness measurements 260 may correspond to image elements of the input data 255, e.g. in a one-to-one or scaled manner.

The predictive model 220 is parameterised by a set of trained parameters that are estimated based on pairs of image data and ground-truth thickness measurements for a plurality of objects. For example, as described in later examples, the predictive model 220 may be trained by supplying sets of photometric and depth data for an object as an input, predicting a set of corresponding thickness measurements and then comparing these thickness measurements to the ground-truth thickness measurements, where an error from the comparison may be used to optimise the parameter values. In one case, the predictive model 220 may comprise a machine learning model such as a neural network architecture. In this case, errors may be back-propagated through the architecture, and a set of optimised parameter values may be determined by applying gradient descent or the like. In other cases, the predictive model may comprise a probabilistic model such as a Bayesian predictive network or the like.

Returning to FIG. 2, the cross-sectional thickness measurements 260 that are output by the predictive model 220 are received by the composition engine 225. The composition engine 225 is configured to compose a plurality of the predicted cross-sectional thickness measurements 260 from the predictive model 220 to provide the output thickness data 245 for the output interface 230. For example, the predicted cross-sectional thickness measurements 260 may be supplied to the composition engine 225 in the form of a plurality of separate image portions; the composition engine 225 receives these separate image portions and reconstructs a single image that corresponds to the input image data 235. In one case, the composition engine 225 may generate a “grayscale” image having dimensions that correspond to the dimensions of the input image data 235 (e.g. that are the same or a scaled version). The composition engine 225 may generate thickness data 245 in a form that may be combined with the original image data 235 as an additional channel. For example, the composition engine 225 or the output interface 230 may be configured to add a “thickness” channel (“T”) to existing RGBD channels in the input image data 235, such that the data output by the output interface 230 comprises RGBDT data (e.g. an RGBDT “image” where pixels in the image have values for each of the channels).

The output of the system 205 of FIG. 2 may be useful in a number of different applications. For example, the thickness data 245 may be used to improve a mapping of a three-dimensional space, may be used by a robotic device to improve a grabbing or grasping operation, or may be used as an enhanced input for further machine learning systems.

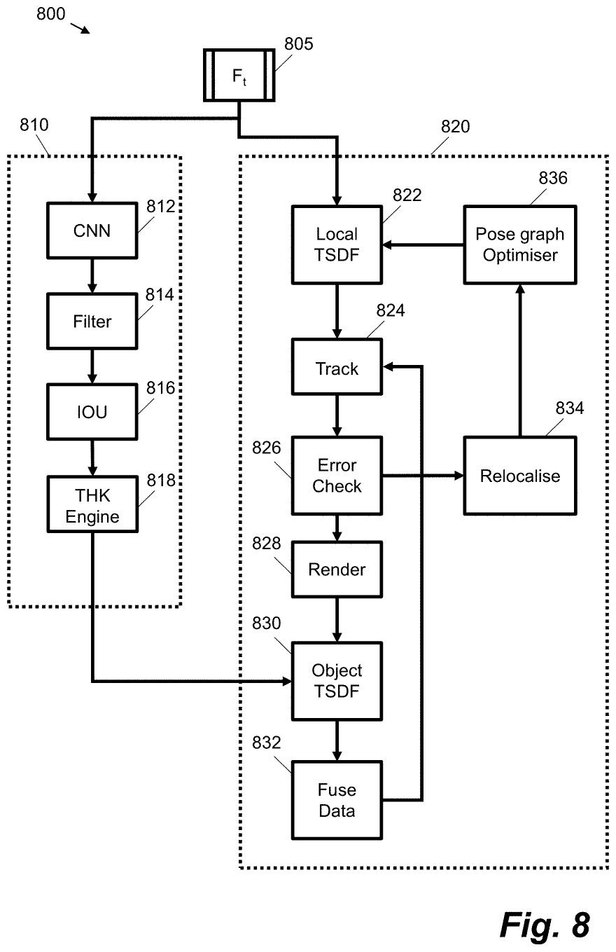

In one case, the system 205 may comprise, or form part of, a mapping system. The mapping system may be configured to receive the output thickness data 245 from the output interface 230 and to use the thickness data 245 to determine truncated signed distance function values for a three-dimensional model of the scene. For example, the mapping system may take as an input depth data and the thickness data 245 (e.g. in the form of a DT or RGBDT channel image) and, together with intrinsic and extrinsic camera parameters, output a representation of a volume representing a scene within a three-dimensional voxel grid. An example mapping system is described later in detail with reference to FIG. 8.

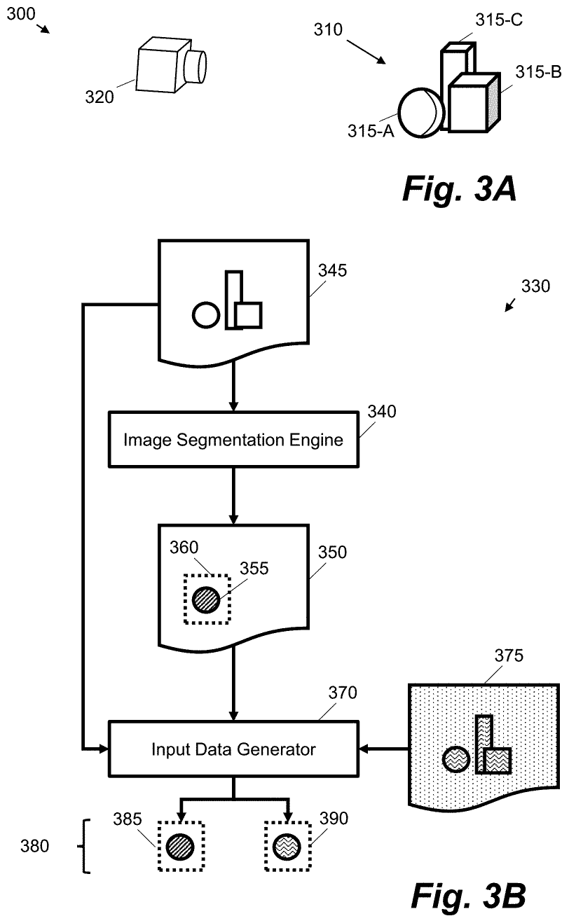

FIG. 3A shows an example of a set of objects 310 being observed by a capture device 320. In the example, there are three objects 315-A, 315-B and 315-C. The set of objects 310 form part of a scene 300, e.g. they may comprise a set of objects on a table or other surface. The present examples are able to estimate cross-sectional thickness measurements for the objects 315 from one or more images captured by the capture device 320.

FIG. 3B shows a set of example components 330 that may be used in certain cases to implement the decomposition engine 215 in FIG. 2. It should be noted that FIG. 3B is only one example, and components other than those shown in FIG. 3B may be used to implement the decomposition engine 215 in FIG. 2. The set of example components 330 comprise an image segmentation engine 340. The image segmentation engine 340 is configured to receive photometric data 345. The photometric data 345 may comprise, as discussed previously, an image as captured by the capture device 320 in FIG. 3A and/or data derived from such an image. In one case, the photometric data 345 may comprise RGB data for a plurality of pixels. The image segmentation engine 340 is configured to generate segmentation data 350 based on the photometric data 345. The segmentation data 350 indicates estimated correspondences between portions of the photometric data 345 and the one or more objects deemed to be present in the image data. If the photometric data 345 in FIG. 3B is taken as an image of the set of objects 310 shown in FIG. 3A, then the image segmentation engine 340 may detect one or more of the objects 315. In FIG. 3B, segmentation data 350 corresponding to the object 315-A is shown. This may form part of a set of segmentation data that also covers a detected presence of objects 315-B and 315-C. In certain cases, not all the objects present in a scene may be detected, e.g. occlusion may prevent object 315-C being detected. Also, as a capture device moves within the scene, different objects may be detected. The present examples are able to function in such a “noisy” environment. For example, the decomposition and prediction enable the thickness measurements to be generated independently of the number of objects detected in a scene.

In FIG. 3B, the segmentation data 350 for detected object 315-A comprises a segmentation mask 355 and a bounding box 360. In other examples, only one of the segmentation mask 355 and the bounding box 360, or a different form of object identification, may be output. The segmentation mask 355 may comprise a label that is applied to a subset of pixels from the original photometric data 345. In one case, the segmentation mask 355 may be a binary mask, where pixels that correspond to a detected object have a value of “1” and pixels that are not related to the detected object have a value of “0”. Different forms of masking and masking data formats may be applied. In yet another case, the image segmentation engine 340 may output values for pixels of the photometric data 345, where the values indicate a possible detected object. For example, a pixel having a value of “0” may indicate that no object is deemed to be associated with that pixel, whereas a pixel having a value of “6” may indicate that a sixth object in a list or look-up table is deemed to be associated with that pixel. Hence, the segmentation data 350 may comprise a series of single channel (e.g. binary) images and/or a single multi-value image. The bounding box 360 may comprise a polygon such as a rectangle that is deemed to surround the pixels associated with a particular object. The bounding box 360 may be output separately as a set of co-ordinates indicating corners of the bounding box 360 and/or may be indicated in any image data output by the image segmentation engine 340. Each object detected by the image segmentation engine 340 may have a different segmentation mask 355 and a different associated bounding box 360.

The configuration of the segmentation data 350 may vary depending on implementation. In one case, the segmentation data 350 may comprise images that are the same resolution as the input photometric data (and e.g. may comprise grayscale images). In certain cases, additional data may also be output by the image segmentation engine 340. In one case, the image segmentation engine 340 may be arranged to output a confidence value indicating a confidence or probability for a detected object, e.g. a probability of a pixel being associated with an object. In certain cases, the image segmentation engine 340 may instead or additionally output a probability that a detected object is associated with a particular semantic class (e.g. as indicated by a string label). For example, the image segmentation engine 340 may output an 88% probability of an object being a “cup”, a 10% probability of the object being a “jug” and a 2% probability of the object being an “orange”. One or more thresholds may be applied by the image segmentation engine 340 before indicating that a particular image element, such as a pixel or image area, is associated with a particular object.

In certain examples, the image segmentation engine 340 comprises a neural network architecture, such as a convolutional neural network architecture, that is trained on supervised (i.e. labelled) data. The supervised data may comprise pairs of images and segmentation masks for a set of objects. The convolutional neural network architecture may be a so-called “deep” neural network, e.g. that comprises a plurality of layers. The object recognition pipeline may comprise a region-based convolutional neural network—RCNN—with a path for predicting segmentation masks. An example configuration for an RCNN with a mask output is described by K. He et al. in the paper “Mask R-CNN”, published in Proceedings of the International Conference on Computer Vision (ICCV), 2017 (1, 5)—(incorporated by reference where applicable). Different architectures may be used (in a “plug-in” manner) as they are developed.

In certain cases, the image segmentation engine 340 may output a segmentation mask where it is determined that an object is present (e.g. a threshold for object presence per se is exceeded) but where it is not possible to determine the type or semantic class of the object (e.g. the class or label probabilities are all below a given threshold). The examples described herein may be able to use the segmentation mask even if it is not possible to determine what the object is, the indication of the extent of “a” object is suitable to allow input data for a predictive model to be generated.

Returning to FIG. 3B, the segmentation data 350 is received by an input data generator 370. The input data generator 370 is configured to process the segmentation data 350, together with the photometric data 345 and depth data 375 to generate portions of image data that may be used as input data 380 for the predictive model, e.g. the predictive model 220 in FIG. 2. The input data generator 370 may be configured to crop the photometric data 345 and the depth data 375 using the bounding box 360. In one case, the segmentation mask 355 may be used to remove a background from the photometric data 345 and the depth data 375, e.g. such that only data associated with object pixels remains. The depth data 375 may comprise data from the depth channel of input image data that corresponds to the photometric data 345 from the photometric channels of the same image data. The depth data 375 may be stored at the same resolution as the photometric data 345 or may be scaled or otherwise processed to result in corresponding cropped portions of photometric data 385 and depth data 390, which form the input data 380 for the predictive model. In certain cases, the photometric data may comprise one or more of: the segmentation mask 355 as cropped using the bounding box 360 and the original photometric data 345 as cropped using the boundary box. Use of the segmentation mask 355 as input without the original photometric data 345 may simplify training and increase prediction speed while use of the original photometric data 345 may enable colour information to be used to predict thickness.

In certain cases, the photometric data 345 and/or depth data 375 may be rescaled to a native resolution of the image segmentation engine 340. Similarly, in certain cases, an output of the image segmentation engine 340 may also be rescaled by one of the image segmentation engine 340 and the input data generator 370 to match a resolution used by the predictive model. As well as, or instead of, a neural network approach, the image segmentation engine 340 may implement at least one of a variety of machine learning methods, including: amongst others, support vector machines (SVMs), Bayesian networks, Random Forests, nearest neighbour clustering and the like. One or more graphics processing units may be used to train and/or implement the image segmentation engine 340. The image segmentation engine 340 may use a set of pre-trained parameters, and/or be trained on one or more training data sets featuring pairs of photometric data 345 and segmentation data 350. In general, the image segmentation engine 340 may be implemented independently and agnostically of the predictive model, e.g. predictive model 220, such that different segmentation approaches may be used in a modular manner in different implementations of the examples.

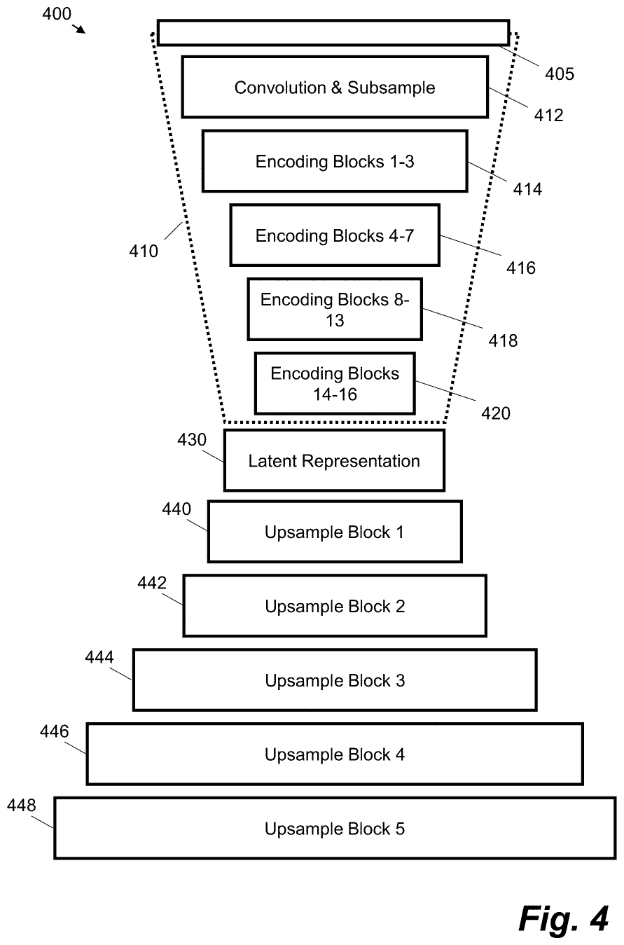

FIG. 4 shows an example of a predictive model 400 that may be used to implement the predictive model 220 shown in FIG. 2. It should be noted that the predictive model 400 is provided as an example only, different predictive models and/or different configurations of the shown predictive model 400 may be used depending on the implementation.

In the example of FIG. 4, the predictive model 400 comprises an encoder-decoder architecture. In this architecture, an input interface 405 receives an image that has channels for data derived from photometric data and data derived depth data. For example, the input interface 405 may be configured to receive RGBD images and/or a depth channel plus a segmentation mask channel. The input interface 405 is configured to convert the received data into a multi-channel feature image, e.g. numeric values for a two-dimensional array with at least four channels representing each of the RGBD values or at least two channels representing a segmentation mask and depth data. The received data may be, for example, 8-bit data representing values in the range of 0 to 255. A segmentation mask may be provided as a binary image (e.g. with values of 0 and 1 respectively indicating the absence and presence of an object). The multi-channel feature image may represent the data as float values in a multidimensional array. In certain cases, the input interface 405 may format and/or pre-process the received data to convert it into a form to be processed by the predictive model 400.

The predictive model 400 of FIG. 4 comprises an encoder 410 to encode the multi-channel feature image. In the architecture of FIG. 4, the encoder 410 comprises a series of encoding components: a first component 412 performs convolutional and subsampling of the data from the input interface 405 and then a set of encoding blocks 414 to 420 encode the data from the first component 412. The encoder 410 may be based on a “ResNet” model (e.g. ResNet101) as described in the 2015 paper “Deep Residual Learning for Image Recognition” by Kaiming He et al (which is incorporated by reference where applicable). The encoder 410 may be trained on one or more image data sets such as ImageNet (as described in ImageNet: A Large-Scale Hierarchical Image Database by Deng et al—2009—incorporated by reference where applicable). The encoder 410 may be either trained as part of an implementation and/or use a set of pre-trained parameter values. The convolution and sub-sampling applied by the first component 412 enables the ResNet architecture to be adapted for image data as described herein, e.g. a combination of photometric and depth data. In certain cases, the photometric data may comprise RGB data, in other cases it may comprise a segmentation mask or silhouette (e.g. binary image data).

The encoder 410 is configured to generate a latent representation 430, e.g. a reduced dimensionality encoding, of the input data. This may comprise, in test examples, a code of dimension 3 by 4 with 2048 channels. The predictive model 400 then comprises a decoder in the form of upsample blocks 440 to 448. The decoder is configured to decode the latent representation 430 to generate cross-sectional thickness measurements for a set of image elements. For example, the output of the fifth upsample block 448 may comprise an image of the same dimensions as the image data received by the input interface 405 but with pixel values representing cross-sectional thickness measurements. Each upsampling block may comprise a bilinear upsampling operation followed be two convolution operations. The decoder may be based on a UNet architecture, as described in the 2015 paper “U-net: Convolutional networks for biomedical image segmentation” by Ronneberger et al (incorporated by reference where applicable). The complete predictive model 400 may be trained to minimise a loss between predicted thickness values and “ground-truth” thickness values set out in a training set. The loss may be an L₂ (squared) loss.

In certain cases, a pre-processing operation performed by the input interface 405 may comprise subtracting a mean of an object region and a mean of a background from the depth data input. This may help the network to focus on an object shape as opposed to absolute depth values.

In certain examples, the image data 235, the photometric data 345 or the image data received by the input interface 405 may comprise silhouette data. This may comprise one or more channels of data that indicates whether pixels correspond to a silhouette of an object. Silhouette data may be equal to, or derived from, the segmentation mask 355 described with reference to FIG. 3B. In certain cases, the image data 235 received by the input interface 210 of FIG. 2 already contains object segmentation data, e.g. an image segmentation engine similar to the image segmentation engine 340 may be applied externally to the system 205. In this case, the decomposition engine 215 may not comprise an image segmentation engine similar to the image segmentation engine 340 of FIG. 3B; instead, the input data generator 370 of FIG. 3B may be adapted to receive the image data 235, as relayed from the input interface 210. In certain cases, the predictive model 220 of FIG. 2 or the predictive model 400 of FIG. 4 may be configured to operate on one or more of: RGB colour data, silhouette data and depth data. For certain applications, RGB data may convey more information than silhouette data, and so lead to more accurate predicted thickness measurements. In certain cases, the predictive models 220 or 400 may be adapted to predict thickness measurements based on silhouette data and depth data as input data; this may be possible in implementations with limited object types where a thickness may be predicted based on an object shape and surface depth. Different combinations of different data types may be used in certain implementations.

In certain cases, the predictive model 220 of FIG. 2 or the predictive model 400 of FIG. 4 may be applied in parallel to multiple sets of input data. For example, multiple instances of a predictive model with common trained parameters may be configured, where each instance receives input data associated with a different object. This can allow quick real-time processing of the original image data. In certain cases, instances of the predictive model may be configured dynamically based on a number of detected objects, e.g. as output by the image segmentation engine 340 in FIG. 3B.

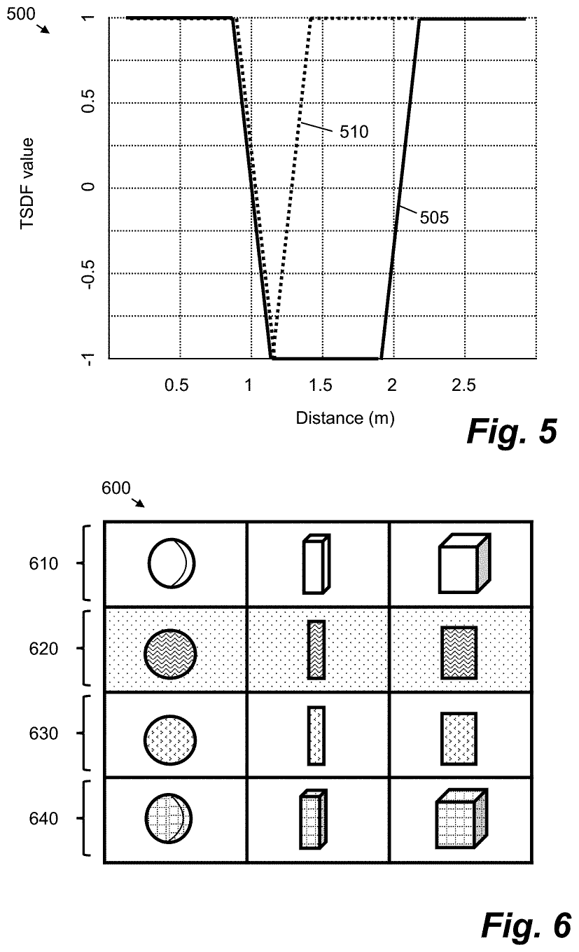

FIG. 5 illustrates how thickness data generated by the examples described herein may be used to improve existing truncated signed distance function (TSDF) values that are generated by the mapping system. FIG. 5 shows a plot 500 of TSDF values as initially generated by an unadapted mapping system for a one-dimensional slice through a three-dimensional model (as indicated by the x-axis showing distance values). The unadapted mapping system may comprise a comparative mapping system. The dashed line 510 within the plot 500 shows that the unadapted mapping system models the surfaces of objects but not their thicknesses. The plot shows a hypothetic example of a surface at 1 m from a camera or origin with a thickness of 1 m. As the unadapted mapping system models the surfaces of objects, beyond the observed surface the TSDF values quickly returns from −1 to 1. However, when the mapping system is adapted to process the thickness data as generated by described examples, the TSDF values may be corrected to indicate the 1 m thickness of the surface. This is shown by the solid line 505. As such the output of examples described herein may be used by reconstruction procedures that yield not only surface in a three-dimensional model space but that explicitly reconstruct the occupied volume of an object.

FIG. 6 shows an example training set 600 that may be used to train one or more of the predictive models 220 and 400 of FIGS. 2 and 4, and the image segmentation engine 340 of FIG. 3B. The training set 600 comprises samples for a plurality of objects. In FIG. 6 a different sample is shown in each column Each sample comprising photometric data 610, depth data 620, and cross-sectional thickness data 630 for one of the plurality of objects. The objects in FIG. 6 may be related to the objects viewed in FIG. 3A, e.g. may be other instances of those objects as captured in one or more images. The photometric data 610 and the depth data 620 may be generated by capturing one or more images of an object with an RGBD camera and/or using synthetic rendering approaches. In certain cases, the photometric data 610 may comprise RGB data. In certain cases, the photometric data 610 may comprise a silhouette of an object, e.g. a binary and/or grayscale image. The silhouette of an object may comprise a segmentation mask.

The cross-sectional thickness data 630 may be generated in a number of different ways. In one case, it may be manually collated, e.g. from known object specifications. In another case, it may be manually measured, e.g. by observing depth values from two or more locations within a defined frame of reference. In yet another case, it may be synthetically generated. The training data 600 may comprise a mixture of samples obtained using different methods, e.g. some manual measurements and some synthetic samples.

Cross-sectional thickness data 630 may be synthetically generated using one or more three-dimensional models 640 that are supplied with each sample. For example, these may comprise Computer Aided Design (CAD) data such as CAD files for the observed objects. In certain cases, the three-dimensional models 640 may be generated by scanning the physical objects. For example, the physical objects may be scanned using a multi-camera rig and a turn-table, where an object shape in three-dimensions is recovered with a Poisson reconstruction configured to output watertight meshes. In certain cases, the three-dimensional models 640 may be used to generate synthetic data for each of the photometric data 610, the depth data 620 and the thickness data 630. For synthetic samples, backgrounds from an image data set may be added (e.g. randomly) and/or textures added to at least the photometric data 610 from a texture dataset. In synthetic samples, objects may be rendered with photorealistic textures yet randomising lighting features across samples (such as a number of lights, their intensity, colour and positions). Per-pixel cross-sectional thickness measurements may be generated using a customised shading function, e.g. as provided by a graphics programming language adapted to performing shading effects. The shading function may return thickness measurements for surfaces hit by image rays from a modelled camera, and ray depth may be used to check which surfaces have been hit. The shading function may use raytracing, in a similar manner to X-ray approaches, to ray trace through three-dimensional models and measure a distance between an observed (e.g. front) surface and a first surface behind the observed surface. The use of measured and synthetic data can enable a training set to be expanded and improve performance of one or more of the predictive models and the image segmentation engines described herein. Using samples with randomised rendering, e.g. as described above, can lead to more robust object detections and thickness predictions, e.g. as the models and engines learn to ignore environmental factors and to focus on shape cues.

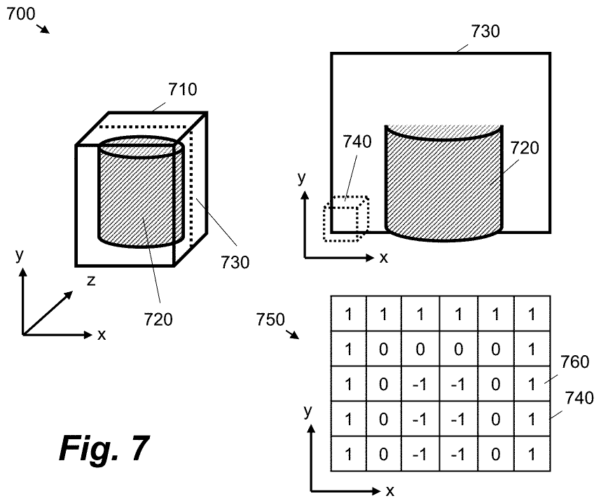

FIG. 7 shows an example 700 of a three-dimensional volume 710 for an object 720 and an associated two-dimensional slice 730 through the volume indicating TSDF values for a set of voxels associated with the slice. FIG. 7 provides an overview of the use of TSDF values to provide context for FIG. 5 and mapping systems that use generated thickness data to improve TSDF measurements, e.g. in three-dimensional models of an environment.

In the example of FIG. 7, three-dimensional volume 710 is split into a number of voxels, where each voxel has a corresponding TSDF value to model an extent of the object 720 within the volume. To illustrate the TSDF values, a two-dimensional slice 730 through the three-dimensional volume 710 is shown in the Figure. In this example, the two-dimensional slice 730 runs through the centre of the object 720 and relates to a set of voxels 740 with a common z-space value. The x and y extent of the two-dimensional slice 730 is shown in the upper right of the Figure. In the lower right, example TSDF values 760 for the voxels are shown.

In the present case, the TSDF values indicate a distance from an observed surface in three-dimensional space. In FIG. 7, the TSDF values indicate whether a voxel of the three-dimensional volume 710 belongs to free space outside of the object 720 or to filled space within the object 720. In FIG. 7, the TSDF values range from 1 to −1. As such values for the slice 730 may be considered as a two-dimensional image 750. Values of 1 represent free space outside of the object 720; whereas values of −1 represent filled space within the object 720. Values of 0 thus represent a surface of the object 720. Although only three different values (“1”, “0”, and “−1”) are shown for ease of explanation, actual values may be decimal values (e.g. “0.54”, or “−0.31”) representing a relative distance to the surface. It should also be noted that whether negative or positive values represent a distance outside of a surface is a convention that may vary between implementations. The values may or may not be truncated depending on the implementation; truncation meaning that distances beyond a certain threshold are set to the floor or ceiling values of “1” and “−1”. Similarly, normalisation may or may not be applied, and ranges other than “1” to “−1” may be used (e.g. values may be “−127 to 128” for 8-bit representation).

In FIG. 7, the edges of the object 720 may be seen by the values of “0”, and the interior of the object 720 by values of “−1”. The TSDF values for the interior of the object 720 may be computed using the thickness data described herein, e.g. to set TSDF values behind a surface of the object 720 determined with a mapping system. In certain examples, as well as a TSDF value, each voxel of the three-dimensional volume may also have an associated weight to allow multiple volumes to be fused into a common volume for an observed environment (e.g. the complete scene in FIG. 3A). In certain cases, the weights may be set per frame of video data (e.g. weights for an object from a previous frame are used to fuse depth data with the surface-distance metric values for a subsequent frame). The weights may be used to fuse depth data in a weighted average manner One method of fusing depth data using surface-distance metric values and weight values is described in the paper “A Volumetric Method for Building Complex Models from Range Images” by Curless and Levoy as published in the Proceedings of SIGGRAPH '96, the 23^{rd} annual conference on Computer Graphics and Interactive Techniques, A C M, 1996 (which is incorporated by reference where applicable). A further method involving fusing depth data using TSDF values and weight values is described in the earlier-cited “KinectFusion” (and which is incorporated by reference where applicable).

FIG. 8 shows an example of a system 800 for mapping objects in a surrounding or ambient environment using video data. The system 800 is adapted to use thickness data, as predicted by described examples, to improve the mapping of objects. Although particular features of the system 800 are described, it should be noted that these are provided as an example, and the described methods and systems of the other Figures may be used in other mapping systems.

The system 800 is shown operating on a frame Fₜ of video data 805, where the components involved iteratively process a sequence of frames from the video data representing an observation or “capture” of the surrounding environment over time. The observation need not be continuous. As with the system 205 shown in FIG. 2, components of the system 800 may be implemented by computer program code that is processed by one or more processors, dedicated processing circuits (such as ASICs, FPGAs or specialised GPUs) and/or a combination of the two. The components of the system 800 may be implemented within a single computing device (e.g. a desktop, laptop, mobile and/or embedded computing device) or distributed over multiple discrete computing devices (e.g. certain components may be implemented by one or more server computing devices based on requests from one or more client computing devices made over a network).

The components of the system 800 shown in FIG. 8 are grouped into two processing pathways. A first processing pathway comprises an object recognition pipeline 810. A second processing pathway comprises a fusion engine 820. It should be noted that certain components described with reference to FIG. 8, although described with reference to a particular one of the object recognition pipeline 810 and the fusion engine 820, may in certain implementations be provided as part of the other one of the object recognition pipeline 810 and the fusion engine 820, while maintaining the processing pathways shown in the Figure. It should also be noted that, depending on the implementation, certain components may be omitted or modified, and/or other components added, while maintaining a general operation as described in examples herein. The interconnections between components are also shown for ease of explanation and may again be modified, or additional communication pathways may exist, in actual implementations.

In FIG. 8, the object recognition pipeline 810 comprises a Convolutional Neural Network (CNN) 812, a filter 814, and an Intersection over Union (IOU) component 816. The CNN 812 may comprise a region-based CNN that generates a mask output (e.g. an implementation of Mask R-CNN). The CNN 812 may be trained on one or more labelled image datasets. The CNN 812 may comprise an instance of at least part of the image segmentation engine 340 of FIG. 3B. In certain cases, the CNN 812 may implement the image segmentation engine 340, where the received frame of data Fₜ comprises the photometric data 345.

The filter 814 receives a mask output of the CNN 812, in the form of a set of mask images for respective detected objects and a set of corresponding object label probability distributions for the same set of detected objects. Each detected object thus has a mask image and an object label probability. The mask images may comprise binary mask images. The filter 814 may be used to filter the mask output of the CNN 812, e.g. based on one or more object detection metrics such as object label probability, proximity to image borders, and object size within the mask (e.g. areas below X pixels² may be filtered out). The filter 814 may act to reduce the mask output to a subset of mask images (e.g. 0 to 100 mask images) that aids real-time operation and memory demands.

The output of the filter 814, comprising a filtered mask output, is then received by the IOU component 816. The IOU component 816 accesses rendered or “virtual” mask images that are generated based on any existing object instances in a map of object instances. The map of object instances is generated by the fusion engine 820 as described below. The rendered mask images may be generated by raycasting using the object instances, e.g. using TSDF values stored within respective three-dimensional volumes such as those shown in FIG. 7. The rendered mask images may be generated for each object instance in the map of object instances and may comprise binary masks to match the mask output from the filter 814. The IOU component 816 may calculate an intersection of each mask image from the filter 814, with each of the rendered mask images for the object instances. The rendered mask image with largest intersection may be selected as an object “match”, with that rendered mask image then being associated with the corresponding object instance in the map of object instances. The largest intersection computed by the IOU component 816 may be compared with a predefined threshold. If the largest intersection is larger than the threshold, the IOU component 816 outputs the mask image from the CNN 812 and the association with the object instance; if the largest intersection is below the threshold, then the IOU component 616 outputs an indication that no existing object instance is detected.

The output of the IOU component 816 is then passed to a thickness engine 818. The thickness engine 818 may comprise at least part of the system 205 shown in FIG. 2. The thickness engine 818 may comprise an implementation of the system 205, where the decomposition engine 215 is configured to use the output of one or more of the CNN 812, filter 814, and the IOU component 816. For example, the output of the CNN 812 may be used by the decomposition engine 215 in a similar manner to the process described with reference to FIG. 3B. The thickness engine 818 is arranged to operate on the frame data 805 and to add thickness data for one or more detected objects, e.g. where the thickness data is associated with the mask image from the CNN 812 and a matched object instance. The thickness engine 818 thus enhances the data stream of the object recognition pipeline 810 and provides another information channel. The enhanced data output by the thickness engine 818 is then passed to the fusion engine 820. The thickness engine 818 in certain cases may receive the mask image output by the IOU component 816.

In the example of FIG. 8, the fusion engine 820 comprises a local TSDF component 822, a tracking component 824, an error checker 826, a renderer 828, an object TSDF component 830, a data fusion component 832, a relocalisation component 834 and a pose graph optimiser 836. Although not shown in FIG. 8 for clarity, in use, the fusion engine 820 operates on a pose graph and a map of object instances. In certain cases, a single representation may be stored, where the map of object instances is formed by the pose graph, and three-dimensional object volumes associated with object instances are stored as part of the pose graph node (e.g. as data associated with the node). In other cases, separate representations may be stored for the pose graph and the set of object instances. As discussed herein, the term “map” may refer to a collection of data definitions for object instances, where those data definitions include location and/or orientation information for respective object instances, e.g. such that a position and/or orientation of an object instance with respect to an observed environment may be recorded.

In the example of FIG. 8, as well as a map of object instances storing TSDF values, an object-agnostic model of the surrounding environment is also used. This is generated and updated by the local TSDF component 822. The object-agnostic model provides a ‘coarse’ or low-resolution model of the environment that enables tracking to be performed in the absence of detected objects. The local TSDF component 822, and the object-agnostic model, may be useful for implementations that are to observe an environment with sparsely located objects. The local TSDF component 822 may not use object thickness data as predicted by the thickness engine 818. It may not be used for environments with dense distributions of objects. Data defining the object-agnostic model may be stored in a memory accessible to the fusion engine 820, e.g. as well as the pose graph and the map of object instances.

In the example of FIG. 8, the local TSDF component 822 receives frames of video data 805 and generates an object-agnostic model of the surrounding (three-dimensional) environment to provide frame-to-model tracking responsive to an absence of detected object instances. For example, the object-agnostic model may comprise a three-dimensional volume, similar to three-dimensional volumes defined for each object, that store TSDF values representing a distance to a surface as formed in the environment. The object-agnostic model does not segment the environment into discrete object instances; it may be considered an ‘object instance’ that represents the whole environment. The object-agnostic model may be coarse or low resolution in the fact that a limited number of voxels of a relatively large size may be used to represent the environment. For example, in one case, a three-dimensional volume for the object-agnostic model may have a resolution of 256×256×256, wherein a voxel within the volume represents approximately a 2 cm cube in the environment. The local TSDF component 822 may determine a volume size and a volume centre for the three-dimensional volume for the object-agnostic model. The local TSDF component 822 may update the volume size and the volume centre upon receipt of further frames of video data, e.g. to account for an updated camera pose if the camera has moved.

In the example 800 of FIG. 8, the object-agnostic model and the map of object instances is provided to the tracking component 824. The tracking component 824 is configured to track an error between at least one of photometric and depth data associated with the frames of video data 805 and one or more of the object-instance-agnostic model and the map of object instances. In one case, layered reference data may be generated by raycasting from the object-agnostic model and the object instances. The reference data may be layered in that data generated based on each of the object-agnostic model and the object instances (e.g. based on each object instance) may be accessed independently, in a similar manner to layers in image editing applications. The reference data may comprise one or more of a vertex map, a normal map, and an instance map, where each “map” may be in the form of a two-dimensional image that is formed based on a recent camera pose estimate (e.g. a previous camera pose estimate in the pose graph), where the vertices and normals of the respective maps are defined in model space, e.g. with reference to a world frame. Vertex and normal values may be represented as pixel values in these maps. The tracking component 824 may then determine a transformation that maps from the reference data to data derived from a current frame of video data 805 (e.g. a so-called “live” frame). For example, a current depth map for time t may be projected to a vertex map and a normal map and compared to the reference vertex and normal maps. Bilateral filtering may be applied to the depth map in certain cases.

The tracking component 824 may align data associated with the current frame of video data with reference data using an iterative closest point (ICP) function. The tracking component 824 may use the comparison of data associated with the current frame of video data with reference data derived from at least one of the object-agnostic model and the map of object instances to determine a camera pose estimate for the current frame (e.g. T_{WC}^{t+1}). This may be performed for example before recalculation of the object-agnostic model (for example before relocalisation). The optimised ICP pose (and invariance covariance estimate) may be used as a measurement constraint between camera poses, which are each for example associated with a respective node of the pose graph. The comparison may be performed on a pixel-by-pixel basis. However, to avoid overweighting pixels belonging to object instances, e.g. to avoid double counting, pixels that have already been used to derive object-camera constraints may be omitted from optimisation of the measurement constraint between camera poses.

The tracking component 824 outputs a set of error metrics that are received by the error checker 826. These error metrics may comprise a root-mean-square-error (RMSE) metric from an ICP function and/or a proportion of validly tracked pixels. The error checker 826 compares the set of error metrics to a set of predefined thresholds to determine if tracking is maintained or whether relocalisation is to be performed. If relocalisation is to be performed, e.g. if the error metrics exceed the predefined thresholds, then the error checker 826 triggers the operation of the relocalisation component 834. The relocalisation component 834 acts to align the map of object instances with data from the current frame of video data. The relocalisation component 834 may use one of a variety of relocalisation methods. In one method, image features may be projected to model space using a current depth map, and random sample consensus (RANSAC) may be applied using the image features and the map of object instances. In this way, three-dimensional points generated from current frame image features may be compared with three-dimensional points derived from object instances ion the map of object instances (e.g. transformed from the object volumes). For example, for each instance in a current frame which closely matches a class distribution of an object instance in the map of object instances (e.g. with a dot product of greater than 0.6) 3D-3D RANSAC may be performed. If a number of inlier features exceeds a predetermined threshold, e.g. 5 inlier features within a 2 cm radius, an object instance in the current frame may be considered to match an object instance in the map. If a number of matching object instances meets or exceeds a threshold, e.g. 3, 3D-3D RANSAC may be performed again on all of the points (including points in the background) with a minimum of 50 inlier features within a 5 cm radius, to generate a revised camera pose estimate. The relocalisation component 834 is configured to output the revised camera pose estimate. This revised camera pose estimate is then used by the pose graph optimiser 836 to optimise the pose graph.

The pose graph optimiser 836 is configured to optimise the pose graph to update camera and/or object pose estimates. This may be performed as described above. For example, in one case, the pose graph optimiser 836 may optimise the pose graph to reduce a total error for the graph calculated as a sum over all the edges from camera-to-object, and from camera-to-camera, pose estimate transitions based on the node and edge values. For example, a graph optimiser may model perturbations to local pose measurements and use these to compute Jacobian terms for an information matrix used in the total error computation, e.g. together with an inverse measurement covariance based on an ICP error. Depending on a configuration of the system 800, the pose graph optimiser 836 may or may not be configured to perform an optimisation when a node is added to the pose graph. For example, performing optimisation based on a set of error metrics may reduce processing demands as optimisation need not be performed each time a node is added to the pose graph. Errors in the pose graph optimisation may not be independent of errors in tracking, which may be obtained by the tracking component 824. For example, errors in the pose graph caused by changes in a pose configuration may be the same as a point-to-plane error metric in ICP given a full input depth image. However, recalculation of this error based on a new camera pose typically involves use of the full depth image measurement and re-rendering of the object model, which may be computationally costly. To reduce a computational cost, a linear approximation to the ICP error produced using the Hessian of the ICP error function may instead be used as a constraint in the pose graph during optimisation of the pose graph.

Returning to the processing pathway from the error checker 826, if the error metrics are within acceptable bounds (e.g. during operation or following relocalisation), the renderer 828 operates to generate rendered data for use by the other components of the fusion engine 820. The renderer 828 may be configured to render one or more of depth maps (i.e. depth data in the form of an image), vertex maps, normal maps, photometric (e.g. RGB) images, mask images and object indices. Each object instance in the map of object instances for example has an object index associated with it. The renderer 828 may make use of the improved TSDF representations that are updated based on object thickness. The renderer 828 may operate on one or more of the object-agnostic model and the object instances in the map of object instances. The renderer 828 may generate data in the form of two-dimensional images or pixel maps. As described previously, the renderer 828 may use raycasting and the TSDF values in the three-dimensional volumes used for the objects to generate the rendered data. Raycasting may comprise using a camera pose estimate and the three-dimensional volume to step along projected rays within a given stepsize and to search for a zero-crossing point as defined by the TSDF values in the three-dimensional volume. Rendering may be dependent on a probability that a voxel belongs to a foreground or a background of a scene. For a given object instance, the renderer 828 may store a ray length of a nearest intersection with a zero-crossing point and may not search past this ray length for subsequent object instances. In this manner occluding surfaces may be correctly rendered. If a value for an existence probability is set based on foreground and background detection counts, then the check against the existence probability may improve the rendering of overlapping objects in an environment.

The renderer 828 outputs data that is then accessed by the object TSDF component 830. The object TSDF component 830 is configured to initialise and update the map of object instances using the output of the renderer 828 and the thickness engine 818. For example, if the thickness engine 818 outputs a signal indicating that a mask image received from the filter 814 matches an existing object instance, e.g. based on an intersection as described above, then the object TSDF component 830 retrieves the relevant object instance, e.g. a three-dimensional object volume storing TSDF values.

The mask image, the predicted thickness data and the object instance are then passed to the data fusion component 832. This may be repeated for a set of mask images forming the filtered mask output, e.g. as received from the filter 814. In certain cases, the data fusion component 832 may also receive or access a set of object label probabilities associated with the set of mask images. Integration at the data fusion component 832 may comprise, for a given object instance indicated by the object TSDF component 830, and for a defined voxel of a three-dimensional volume for the given object instance, projecting the voxel into a camera frame pixel, i.e. using a recent camera pose estimate, and comparing the projected value with a received depth map for the frame of video data 805. In certain cases, if the voxel projects into a camera frame pixel with a depth value (i.e. a projected “virtual” depth value based on a projected TSDF value for the voxel) that is less than a depth measurement (e.g. from a depth map or image received from an RGB-D capture device) plus a truncation distance, then the depth measurement may be fused into the three-dimensional volume. The thickness values in the thickness data may then be used to set TSDF values for voxels behind a front surface of the modelled object. In certain cases, as well as a TSDF value, each voxel also has an associated weight. In these cases, fusion may be applied in a weighted average manner.

In certain cases, this integration may be performed selectively. For example, integration may be performed based on one or more conditions, such as when error metrics from the tracking component 824 are below predefined thresholds. This may be indicated by the error checker 826. Integration may also be performed with reference to frames of video data where the object instance is deemed to be visible. These conditions may help to maintain the reconstruction quality of object instances in a case that a camera frame drifts.

The system 800 of FIG. 8 may operate iteratively on frames of video data 805 to build a robust map of object instances over time, together with a pose graph indicating object poses and camera poses. The map of object instances and the pose graph may then be made available to other devices and systems to allow navigation and/or interaction with the mapped environment. For example, a command from a user (e.g. “bring me the cup”) may be matched with an object instance within the map of object instances (e.g. based on an object label probability distribution or three-dimensional shape matching), and the object instance and object pose may be used by a robotic device to control actuators to extract the corresponding object from the environment. Similarly, the map of object instances may be used to document objects within the environment, e.g. to provide an accurate three-dimensional model inventory. In augmented reality applications, object instances and object poses, together with real-time camera poses, may be used to accurately augment an object in a virtual space based on a real-time video feed.

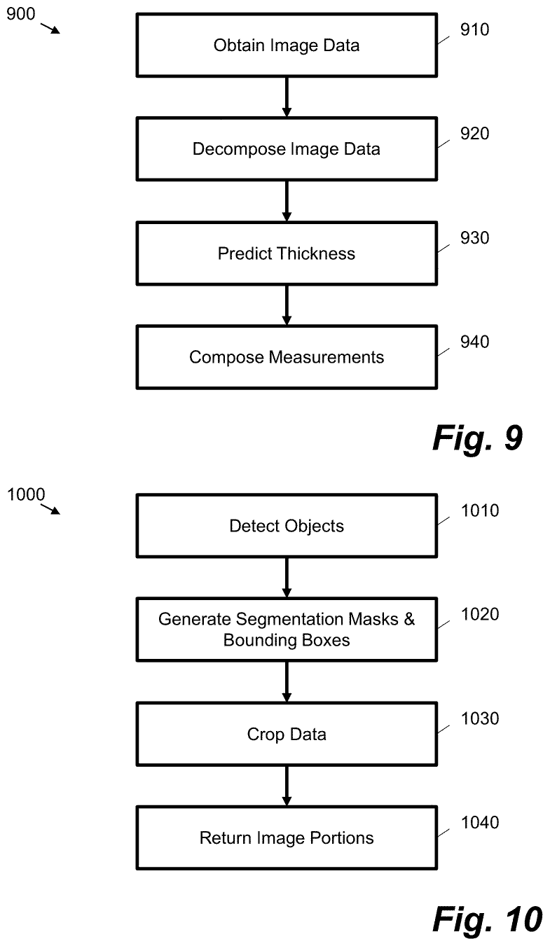

FIG. 9 shows a method 900 of processing image data according to an example. The method may be implemented using the systems described herein or using alternative systems. The method 900 comprises obtaining image data for a scene at block 910. The scene may feature a set of objects, e.g. as shown in FIG. 3A Image data may be obtained directly from a capture device, such as camera 120 in FIG. 1A or camera 320 in FIG. 3A, and/or loaded from a storage device, such as a hard disk or a non-volatile solid-state memory. Block 910 may comprise loading a multi-channel RGBD image into memory for access for blocks 920 to 940.

At block 920, the image data is decomposed to generate input data for a predictive model. In this case, decomposition includes determining portions of the image data that correspond to the set of objects in the scene. This may comprise actively detecting objects and indicating areas of the image data that contain each object, and/or processing segmentation data that is received as part of the image data. Each portion of image data following decomposition may correspond to a different detected object.

At block 930, cross-sectional thickness measurements for the portions are predicted using the predictive model. For example, this may comprise supplying the decomposed portions of image data to the predictive model as an input and outputting the cross-sectional thickness measurements as a prediction. The predictive model may comprise a neural network architecture, e.g. similar to that shown in FIG. 4. The input data may comprise, for example, one of: RGB data; RGB and depth data; or silhouette data (e.g. a binary mask for an object) and depth data. A cross-sectional thickness measurement may comprise an estimated thickness value for a portion of a detected object that is associated with a particular pixel. Block 930 may comprise applying the predictive model serially and/or in parallel to each portion of the image data output following block 920. The thickness value may be provided in units of metres or centimetres.

At block 940, the predicted cross-sectional thickness measurements for the portions of the image data are composed to generate output image data comprising thickness data for the set of objects in the scene. This may comprise generating an output image that corresponds to an input image, wherein the pixel values of the output image represent predicted thickness values for portions of objects that are observed within the scene. The output image data may, in certain cases, comprise the original image data plus an extra “thickness” channel that stores the cross-sectional thickness measurements.

FIG. 10 shows a method 1000 of decomposing the image data according to one example. The method 1000 may be used to implement block 920 in FIG. 9. In other cases, block 920 may be implemented by receiving data that has previously been produced by performing method 1000.

At block 1010, photometric data such as an RGB image is received. A number of objects are detected in the photometric data. This may comprise applying an objection recognition pipeline, e.g. similar to the image segmentation engine 340 in FIG. 3B or the object recognition pipeline 810 of FIG. 8. The object recognition pipeline may comprise a trained neural network to detect objects. At block 1020, segmentation data for the scene is generated. The segmentation data indicates estimated correspondences between portions of the photometric data and the set of objects in the scene. In the present example, the segmentation data comprises a segmentation mask and a bounding box for each detected object. At block 1030, data derived from the photometric data received at block 1010 is cropped for each object based on the bounding boxes generated at block 1020. This may comprise cropping one or more of received RGB data and a segmentation mask output at block 1020. Depth data associated with the photometric data is also cropped. At block 1040, a number of image portions are output. For example, an image portion may comprise cropped portions of data derived from photometric and depth data for each detected object. In certain cases, one or more of the photometric data and the depth data may be processed using the segmentation mask to generate the image portions. For example, the segmentation mask may be used to remove a background in the image portions. In other case, the segmentation mask itself may be used as image portion data, together with depth data.

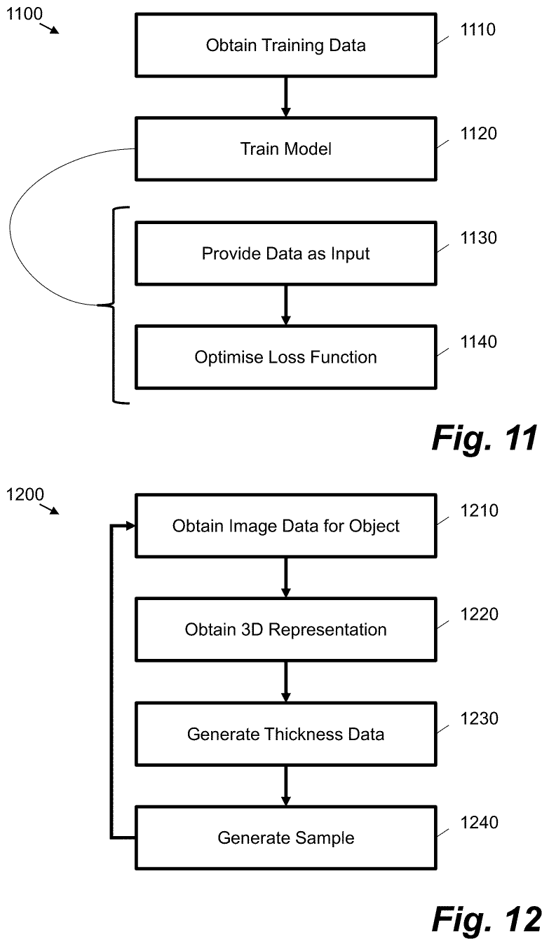

FIG. 11 shows a method 1100 of training a system for estimating a cross-sectional thickness of one or more objects. The system may be system 205 of FIG. 2. The method 1100 may be performed at a configuration stage prior to performing the method 900 of FIG. 9. The method 1100 comprises obtaining training data at block 1110. The training data comprises samples for a plurality of objects. The training data may comprise training data similar to that shown in FIG. 6. Each sample of the training data may comprise photometric data, depth data, and cross-sectional thickness data for one of the plurality of objects. In certain cases, each sample may comprise a colour image, a depth image, and a thickness rendering for an object. In other cases, each sample may comprise a segmentation mask, depth image, and a thickness rendering for an object.

At block 1120, the method comprises training a predictive model of the system using the training data. The predictive model may comprise a neural network architecture. In one case, the predictive model may comprise an encoder-decoder architecture such as that shown in FIG. 4. In other cases, the predictive model may comprise a convolutional neural network. Block 1120 includes two sub-blocks 1130 and 1140. At sub-block 1130, image data from the training data are input to the predictive model. The image data may comprise one or more of: a segmentation mask and depth data; colour data and depth data; and a segmentation mask, colour data and depth data. At sub-block 1140, a loss function associated with the predictive model is optimised. The loss function may be based on a comparison of an output of the predictive model and the cross-sectional thickness data from the training data. For example, the loss function may include a squared error between the output of the predictive model and the ground-truth values. Blocks 1130 and 1140 may be repeated for a plurality of samples to determine a set of parameter values for the predictive model.

In certain cases, object segmentation data associated with at least the photometric data may also be obtained. The method 1100 may then also comprise training an image segmentation engine of the system, e.g. the image segmentation engine 340 of FIG. 3 or the object recognition pipeline 810 of FIG. 8. This may include providing at least the photometric data as an input to the image segmentation engine and optimising a loss function based on an output of the image segmentation engine and the object segmentation data. This may be performed at a configuration stage prior to performing one or more of the methods 900 and 1000 of FIGS. 9 and 10. In other cases, the image segmentation engine of the system may comprise a pre-trained segmentation engine. In certain cases, the image segmentation engine and the predictive model may be jointly trained in a single system.

FIG. 12 shows a method 1200 of generating a training set. The training set may comprise the example training set 600 of FIG. 6. The training set is useable to train a system for estimating a cross-sectional thickness of one or more objects. This system may be the system 205 of FIG. 2. The method 1200 is repeated for each object in a plurality of objects. The method 1200 may be performed prior to the method 1100 of FIG. 11, where the generated training set is used as the training data in block 1110.

At block 1210, image data for a given object is obtained. In this case, the image data comprises photometric data and depth data for a plurality of pixels. For example, the image data may comprise photometric data 610 and depth data 620 as shown in FIG. 6. In certain cases, the image data may comprise RGB-D image data. In other cases, the image data may be generated synthetically, e.g. by rendering the three-dimensional representation described below.

At block 1220, a three-dimensional representation for the object is obtained. This may comprise a three-dimensional model, such as one of the models 640 shown in FIG. 6. At block 1230, cross-sectional thickness data is generated for the object. This may comprise determining a cross-sectional thickness measurement for each pixel of the image data obtained at block 1210. Block 120 may comprise applying ray-tracing to the three-dimensional representation to determine a first distance to a first surface of the object and a second distance to a second surface of the object. The first surface may be a “front” of the object that is visible, and the second surface may be a “rear” of the object that is not visible, but that is indicated in the three-dimensional representation. As such, the first surface may be closer to an origin for the ray-tracing than the second surface. Based on a difference between the first distance and the second distance a cross-sectional thickness measurement for the object may be determined. This process, i.e. ray-tracing and determining a cross-sectional thickness measurement, may be repeated for a set of pixels that correspond to the image data from block 1210.

At block 1240, a sample of input data and ground-truth output data for the object may be generated. This may comprise the photometric data 610, the depth data 620 and the cross-sectional thickness data 630 shown in FIG. 6. The input data may be determined based on the image data and may be used in block 1130 of FIG. 11. The ground-truth output data may be determined based on the cross-sectional thickness data and may be used in block 1140 of FIG. 11.

In certain cases, the image data and the three-dimensional representations for the plurality of objects may be used to generate additional samples of synthetic training data. For example, the three-dimensional representations may be used with randomised conditions to generate different input data for an object. In one case, block 1210 may be omitted and the input and output data may be generated based on the three-dimensional representations alone.

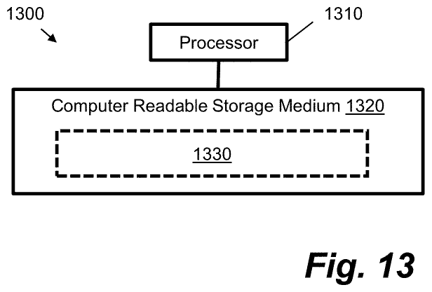

Examples of functional components as described herein with reference to FIGS. 2, 3, 4 and 8 may comprise dedicated processing electronics and/or may be implemented by way of computer program code executed by a processor of at least one computing device. In certain cases, one or more embedded computing devices may be used. FIG. 13 shows a computing device 1300 that may be used to implement the described systems and methods. The computing device 1300 comprises at least one processor 1310 operating in association with a computer readable storage medium 1320 to execute computer program code 1330. The computer readable storage medium may comprise one or more of, for example: volatile memory, non-volatile memory, magnetic storage, optical storage and/or solid-state storage. In an embedded computing device, the medium 1320 may comprise solid state storage such as an erasable programmable read only memory and the computer program code 1330 may comprise firmware. In other cases, the components may comprise a suitably configured system-on-chip, application-specific integrated circuit and/or one or more suitably programmed field-programmable gate arrays. In one case, the components may be implemented by way of computer program code and/or dedicated processing electronics in a mobile computing device and/or a desktop computing device. In one case, the components may be implemented, as well as or instead of the previous cases, by one or more graphical processing units executing computer program code. In certain cases, the components may be implemented by way of one or more functions implemented in parallel, e.g. on multiple processors and/or cores of a graphics processing unit.

In certain cases, the apparatus, systems or methods described above may be implemented with, or for, robotic devices. In these cases, the thickness data, and/or a map of object instances generated using the thickness data, may be used by the device to interact with and/or navigate a three-dimensional space. For example, a robotic device may comprise a capture device, a system as shown in FIG. 2 or 8, an interaction engine and one or more actuators. The one or more actuators may enable the robotic device to interact with a surrounding three-dimensional environment. In one case, the robotic device may be configured to capture video data as the robotic device navigates a particular environment (e.g. as per device 130 in FIG. 1A). In another case, the robotic device may scan an environment, or operate on video data received from a third party, such as a user with a mobile device or another robotic device. As the robotic device processes the video data, it may be arranged to generate thickness data and/or a map of object instances as described herein. The thickness data and/or a map of object instances may be streamed (e.g. stored dynamically in memory) and/or stored in data storage device. The interaction engine may then be configured to access the generated data to control the one or more actuators to interact with the environment. In one case, the robotic device may be arranged to perform one or more functions. For example, the robotic device may be arranged to perform a mapping function, locate particular persons and/or objects (e.g. in an emergency), transport objects, perform cleaning or maintenance etc. To perform one or more functions the robotic device may comprise additional components, such as further sensory devices, vacuum systems and/or actuators to interact with the environment. These functions may then be applied based on the thickness data and/or map of object instances. For example, a domestic robot may be configured to grasp or navigate an object based on a predicted thickness of the object.

The above examples are to be understood as illustrative. Further examples are envisaged. It is to be understood that any feature described in relation to any one example may be used alone, or in combination with other features described, and may also be used in combination with one or more features of any other of the examples, or any combination of any other of the examples. For example, the methods described herein may be adapted to include features described with reference to the system examples and vice versa. Furthermore, equivalents and modifications not described above may also be employed without departing from the scope of the invention, which is defined in the accompanying claims.

What is claimed is:

1. A method of processing image data, the method comprising:
obtaining image data for a scene, the scene featuring a set of objects;
decomposing the image data to generate input data for a predictive model, including determining portions of the image data that correspond to the set of objects in the scene, each portion corresponding to a different object;
predicting cross-sectional thickness measurements for the portions using the predictive model; and
composing the predicted cross-sectional thickness measurements for the portions of the image data to generate output image data comprising thickness data for the set of objects in the scene.

2. The method of claim 1, wherein the image data comprises at least photometric data for a scene and decomposing the image data comprises:
generating segmentation data for the scene from the photometric data, the segmentation data indicating estimated correspondences between portions of the photometric data and the set of objects in the scene.

3. The method of claim 2, wherein generating segmentation data for the scene comprises:
detecting objects that are shown in the photometric data; and
generating a segmentation mask for each detected object,
wherein decomposing the image data comprises, for each detected object, cropping an area of the image data that contains the segmentation mask.

4. The method of claim 1, wherein the image data comprises photometric data and depth data for a scene, and wherein the input data comprises data derived from the photometric data and data derived from the depth data, the data derived from the photometric data comprising one or more of colour data and a segmentation mask.

5. The method of claim 4, comprising:
using the photometric data, the depth data and the thickness data to update a three-dimensional model of the scene.

6. The method of claim 5, wherein the three-dimensional model of the scene comprises a truncated signed distance function (TSDF) model.

7. The method of claim 1, wherein the image data comprises a colour image and a depth map, and wherein the output image data comprises a pixel map comprising pixels that have associated values for cross-sectional thickness.

8. A system for processing image data, the system comprising:
an input interface to receive image data;
an output interface to output thickness data for one or more objects present in the image data received at the input interface;
a predictive model to predict cross-sectional thickness measurements from input data, the predictive model being parameterised by trained parameters that are estimated based on pairs of image data and ground-truth thickness measurements for a plurality of objects;
a decomposition engine to generate the input data for the predictive model from the image data received at the input interface, the decomposition engine being configured to determine correspondences between portions of the image data and one or more objects deemed to be present in the image data, each portion corresponding to a different object; and
a composition engine to compose a plurality of predicted cross-sectional thickness measurements from the predictive model to provide the output thickness data for the output interface.

9. The system of claim 8, wherein the image data comprises photometric data and the decomposition engine comprises an image segmentation engine to generate segmentation data based on the photometric data, the segmentation data indicating estimated correspondences between portions of the photometric data and the one or more objects deemed to be present in the image data.

10. The system of claim 9, wherein the image segmentation engine comprises:
a neural network architecture to detect objects within the photometric data and to output segmentation masks for any detected objects.

11. The system of claim 10, wherein the neural network architecture comprises a region-based convolutional neural network—RCNN—with a path for predicting segmentation masks.

12. The system of claim 9, wherein the decomposition engine is configured to crop sections of the image data based on bounding boxes received from the image segmentation engine, wherein each object detected by the image segmentation engine has a different associated bounding box.

13. The system of claim 8, wherein the image data comprises photometric data and depth data for a scene, and wherein the input data comprises data derived from the photometric data and data derived from the depth data, the data derived from the photometric data comprising a segmentation mask, and wherein the predictive model comprises:
an input interface to receive the photometric data and the depth data and to generate a multi-channel feature image;
an encoder to encode the multi-channel feature image as a latent representation; and
a decoder to decode the latent representation to generate cross-sectional thickness measurements for a set of image elements.

14. The system of claim 8, wherein the image data received at the input interface comprises one or more views of a scene, and the system comprises:
a mapping system to receive output thickness data from the output interface and to use the thickness data to determine truncated signed distance function values for a three-dimensional model of the scene.

15. A method of training a system for estimating a cross-sectional thickness of one or more objects, the method comprising:
obtaining training data comprising samples for a plurality of objects, each sample comprising image data and cross-sectional thickness data for one of the plurality of objects; and
training a predictive model of the system using the training data, including:
providing at least data derived from the image data from the training data as an input to the predictive model; and
optimising a loss function based on an output of the predictive model and the cross-sectional thickness data from the training data.

16. The method of claim 15, comprising:
obtaining object segmentation data associated with the image data;
training an image segmentation engine of the system, including:
providing the image data as an input to the image segmentation engine; and
optimising a loss function based on an output of the image segmentation engine and the object segmentation data.

17. The method of claim 16, wherein each sample comprises photometric data and depth data and training the predictive model comprises providing data derived from the photometric data and data derived from the depth data as an input to the predictive model.

18. The method of claim 15, wherein obtaining the training data comprises generating the training data, the generating the training data comprising, for each object in the plurality of objects:
obtaining the image data for the object, the image data comprising at least photometric data for a plurality of pixels;
obtaining a three-dimensional representation for the object;
generating cross-sectional thickness data for the object, including:
applying ray-tracing to the three-dimensional representation to determine a first distance to a first surface of the object and a second distance to a second surface of the object, the first surface being closer to an origin for the ray-tracing than the second surface; and
determining a cross-sectional thickness measurement for the object based on a difference between the first distance and the second distance,
wherein the ray-tracing and the determining of the cross-sectional thickness measurement is repeated for a set of pixels corresponding to the plurality of pixels to generate the cross-sectional thickness data for the object, the cross-sectional thickness data comprising the cross-sectional thickness measurements and corresponding to the obtained image data; and
generating a sample of input data and ground-truth output data for the object, the input data comprising the image data and the ground-truth output data comprising the cross-sectional thickness data.

19. The method of claim 18, comprising:
using the image data and the three-dimensional representations for the plurality of objects to generate additional samples of synthetic training data.

20. A robotic device comprising:
at least one capture device to provide frames of video data comprising colour data and depth data;
the system of claim 8, wherein the input interface is communicatively coupled to the at least one capture device;
one or more actuators to enable the robotic device to interact with a surrounding three-dimensional environment; and
an interaction engine comprising at least one processor to control the one or more actuators,
wherein the interaction engine is to use the output image data from the output interface of the system to interact with objects in the surrounding three-dimensional environment.
